(19) United States
(12) Patent Application Publication
(10) Pub. No.: US 2006/0172850 A1
(43) Pub. Date: Aug. 3, 2006

(54) Six-speed powertrain of automatic transmission for vehicle

(76) Inventor: Duk Hwan Sung, Anyang-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/302,072

(22) Filed: Dec. 12, 2005

(30) Foreign Application Priority Data
Feb. 3, 2005 (KR) 10-2005-0009894

(51) Int. Cl. F16H 3/44

(52) U.S. Cl. 475/269

(57) ABSTRACT

A six-speed powertrain of an automatic transmission for a vehicle can realize six forward speeds and two reverse speeds with a smaller number of planetary gear sets than that of the prior art by including a stepped pinion type planetary gear set that has corresponding pinion gears of two planetary gear sets connected to each other as one body, and has a simpler scheme such that a small automatic transmission can be realized. Such a transmission has light weight and reduced manufacturing costs.

### CROSS-REFERENCE TO RELATED APPLICATION

This application claims priority to and the benefit of Korean Patent Application No. 10-2005-0009894 filed in the Korean Intellectual Property Office on Feb. 03, 2005, the entire contents of which are incorporated herein by reference.

### BACKGROUND OF THE INVENTION

(a) Field of the Invention

The present invention relates to a six-speed powertrain of an automatic transmission for a vehicle. More particularly, the present invention relates to a six-speed powertrain of an automatic transmission for a vehicle that can realize six forward speeds and two reverse speeds, with a smaller number of planetary gear sets than that of the prior art by including a stepped pinion type planetary gear set and a simpler scheme such that a small sized automatic transmission can be realized with light weight and reduced manufacturing costs.

(b) Description of the Related Art

A multi-stage gearshift mechanism of an automatic transmission includes a plurality of planetary gear sets. A powertrain having such a plurality of planetary gear sets varies the torque in multi-stages and outputs it to an output shaft when receiving a converted engine torque from a torque converter.

The more speeds the powertrain of an automatic transmission has, the better the power performance and fuel consumption. Therefore, it is desirable for powertrains to have as many speeds as possible.

Even for the same number of speeds, durability, power transmission efficiency, and size/weight of a transmission are substantially dependent on how the planetary gear sets are arranged. Therefore, research for more structural strength, less power loss, and more compact packaging are continuously being conducted.

Usually, development of a powertrain using planetary gear sets does not devise a wholly new type of planetary gear set. To the contrary, it invokes how single/double pinion planetary gear sets are combined, and how clutches, brakes, and one-way clutches are disposed to the combination of planetary gear sets such that required shift speeds and speed ratios are realized with minimal power loss.

For a manual transmission, too many speeds cause a driver the inconvenience of excessive manual shifting. However, for an automatic transmission, a transmission control unit automatically executes shifting by controlling the operation of the powertrain, and therefore, more speeds usually implies more merits.

Accordingly, research of four-speed and five-speed powertrains has been undertaken, and recently, a powertrain of an automatic transmission enabling six forward speeds and one reverse speed has been developed.

An example of such research may be found in a Lepelletier type powertrain of an automatic transmission disclosed in European Patent No. 0 434 525 B1, i.e., German patent 690 10 472 T2.

Because the Lepelletier patent has a relatively simple scheme and high performance transmission, the Lepelletier type powertrain is widely utilized. The Lepelletier type powertrain has merit in that a small transmission can be realized, but it is necessary for the number of constituent elements and space to be further reduced. A new scheme is needed that has a simpler scheme by reducing the number of constituent elements and can therefore realize a smaller transmission. The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide a six-speed powertrain of an automatic transmission having advantages in that it can realize six forward speeds and two reverse speeds, have a smaller number of planetary gear sets than that of the prior art by including a stepped pinion type planetary gear set that has corresponding pinion gears of two planetary gear sets connected to each other as one body, have a simpler scheme such that a small automatic transmission can be realized, have light weight, and have reduced manufacturing costs.

An exemplary six-speed powertrain of an automatic transmission for a vehicle according to an embodiment of the present invention includes a stepped pinion type planetary gear set in which two planetary gear sets are connected to each other by corresponding pinion gears.

An exemplary six-speed powertrain of an automatic transmission for a vehicle according to an embodiment of the present invention includes: a first planetary gear set receiving a rotating power of an input shaft; a second planetary gear set outputting the power after changing the speed, wherein a pinion gear of the first planetary gear set and a pinion gear of the second planetary gear set are connected to each other as one body to form a stepped pinion type planetary gear set; a plurality of clutches variably connecting operational elements of the first planetary gear set to an input shaft such that a rotating power of the input shaft can be transmitted to a selected operational element of the first planetary gear set; and a plurality of brakes disposed between a corresponding operational element of the two planetary gear sets and a transmission housing such that the plurality of brakes can stop a selected operational element of the first and second planetary gear sets.

The plurality of clutches includes first, second, and third clutches respectively disposed between a ring gear, a sun gear, and a carrier of the first planetary gear set and the input shaft such that a respective operational element of the first planetary gear set can be variably connected to the input shaft. The plurality of brakes includes first, second, and third brakes respectively disposed between a carrier and a sun gear of the second planetary gear set, the sun gear of the first planetary gear set, and the transmission housing such that the plurality of brakes can stop the respective corresponding operational element. A ring gear of the second planetary gear set is connected to an output shaft such that the ring gear of the second planetary gear set always acts as an output element.

### BRIEF DESCRIPTION OF THE DRAWINGS

FIG. 1 shows a powertrain according to an exemplary embodiment of the present invention.

FIG. 2 shows an operational chart of the powertrain according to the exemplary embodiment of the present invention.

FIG. 3 shows speed ratios of the powertrain according to the exemplary embodiment of the present invention.

FIG. 4 shows a powertrain according to another exemplary embodiment of the present invention.

### DESCRIPTION OF THE EMBODIMENTS

Exemplary embodiments of the present invention will hereinafter be described in detail with reference to the accompanying drawings.

Description of Reference Numerals Indicating Primary Elements in the Drawings:
B1: first brake B2: the second brake
B3: third brake C1: the first clutch
C2: second clutch C3: the third clutch
P1, P2: pinion PC1, PC2: carrier
PG1: first planetary gear set PG2: second planetary gear set
PG3: stepped pinion type planetary gear set
R1, R2: ring gear S1, S2: sun gear

A six-speed powertrain of an automatic transmission of a vehicle according to an exemplary embodiment of the present invention includes a stepped pinion type planetary gear set including two planetary gear sets. A powertrain according to the exemplary embodiment of the present invention can realize six forward speeds and two reverse speeds and may have less number of planetary gear sets than the Lepelletier type.

A six-speed powertrain according to the exemplary embodiment of the present invention is described hereinafter.

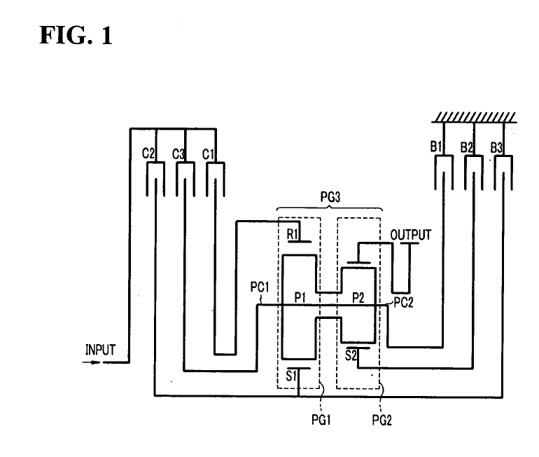

As shown in FIG. 1 to FIG. 3, according to the exemplary embodiment of the present invention, the powertrain may include a stepped pinion type planetary gear set PG3 including two sub-planetary gear sets PG1 and PG2, and three clutches C1, C2, and C3, and three brakes B1, B2, and B3 as frictional elements.

As described above, a powertrain according to an exemplary embodiment of the present invention includes one more brake compared to the Lepelletier type powertrain of the prior art. However, according to the powertrain of the exemplary embodiment of the present invention, because the number of planetary gear sets is two, the powertrain has the merits that the number of components is reduced and a scheme of the powertrain is simplified. In addition, because the number of planetary gear sets, which occupy a relatively larger volume than the other components, is reduced, the overall volume of the transmission can be minimized.

More particularly, a powertrain according to an exemplary embodiment of the present invention includes two sub-planetary gear sets PG1 and PG2 respectively including a sun gear, a carrier, and a ring gear. In addition, a powertrain according to an exemplary embodiment of the present invention includes a stepped pinion type planetary gear set PG3 in which two corresponding pinion gears P1 and P2 of the sub-planetary gear sets PG1 and PG2 are connected with each other. In addition, a powertrain according to an exemplary embodiment of the present invention includes three clutches C1, C2, and C3 and three brakes B1, B2, and B3 transmitting power to the constituent elements and stopping the constituent elements of the stepped pinion type planetary gear set PG3.

Hereinafter, the two sub-planetary gear sets PG1 and PG2 are called the first planetary gear set PG1 and the second planetary gear set PG2. In addition, the two corresponding pinion gears P1 and P2 of both sides are integrally connected in the stepped pinion type planetary gear set PG3. Therefore, a carrier of the first planetary gear set PG1 and the second planetary gear set PG2 can be indicated by one reference numeral but in this specification it is indicated as PC1 and PC2.

The connecting relations between the operational elements according to the exemplary embodiment of the present invention are described hereinafter.

Clutches variably connecting the operational elements of the first planetary gear set PG1 to an input shaft are disposed such that a rotating power of the input shaft can be transmitted to a selected operational element of the first planetary gear set PG1. That is, in the first planetary gear set PG1 of the stepped pinion type planetary gear set PG3 located at a side of the input shaft, a ring gear R1 is variably connected to the input shaft through the first clutch C1, a sun gear S1 is variably connected to the input shaft through the second clutch C2, and a carrier PC1 is variably connected to the input shaft through the third clutch C3.

Generally, the input shaft receives a rotating power of the engine via a turbine of a torque converter.

In addition, a plurality of brakes are disposed between a transmission housing and corresponding operational elements of the two planetary gear sets such that the brakes stop selected elements of the first and second planetary gear sets PG1 and PG2. That is, the first brake B1 stops the carrier PC2 of the second planetary gear set PG2 disposed at the output side of the stepped pinion type planetary gear set PG3. The first brake B1 is interposed between the carrier PC2 of the second planetary gear set PG2 and the transmission housing. 100311 In addition, the second brake B2, which stops the sun gear S2 of the second planetary gear set PG2, is interposed between the sun gear S2 of the second planetary gear set PG2 and the transmission housing. The third brake B3, which stops the sun gear S1 of the first planetary gear set PG1, is interposed between the sun gear S1 of the first planetary gear set PG1 and the transmission housing. The ring gear R2 of the second planetary gear set PG2 is connected to the output shaft so as to operate as an output element.

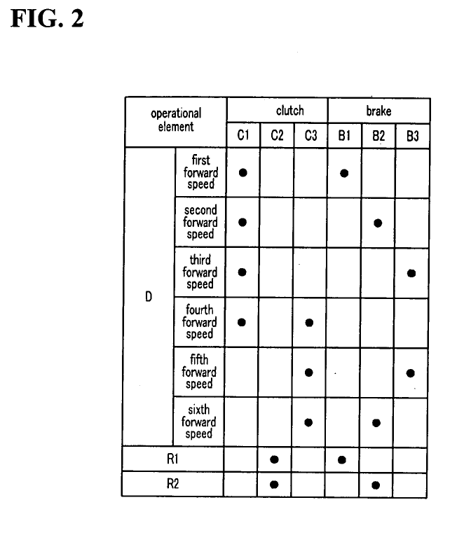

In FIG. 2, an arrangement wherein power is transmitted to a differential apparatus by which a transfer drive gear is engaged to a transfer driven gear by a final decreasing gear is omitted, because embodiments of the present invention can be realized without such an arrangement. In addition, as shown, the two corresponding pinion gears P1 and P2 of the stepped pinion type planetary gear set PG3 are connected with each other. Therefore, the two corresponding pinion gears P1 and P2 are connected by a shaft or a power delivery member such that the two pinion gears P1 and P2 integrally rotate. That is, because the two pinion gears P1 and P2 integrally rotate, the rotating speed and revolution speed of the two pinion gears P1 and P2 are identical and the rotating speed of the two carriers PC1 and PC2 are also identical. The number of gear teeth of the sun gear, the ring gear, and the pinion gear of the two planetary gear sets is different from each other.

The scheme and analyzing method of the stepped pinion type planetary gear set are described in SAE PAPER 810102 “The Lever Analogy: a New Tool in Transmission Analysis,” which is incorporated by reference herein in its entirety.

According to an exemplary embodiment of the present invention, the powertrain selects the input element from among the sun gear, the carrier, and the ring gear corresponding to an operation of the frictional elements (clutches and brakes) operated or not operated by a transmission control unit (TCU). The TCU may comprise a processor, memory and associated hardware and software as may be selected and programmed by a person of ordinary skill in the art based on the teaching herein. In addition, the powertrain realizes six forward speeds and two reverse speeds by selecting a reaction element of the sun gear, the carrier, and the ring gear. Also, according to an exemplary embodiment of the present invention, regarding the frictional elements operated or not operated by the TCU in a process of shift output, an operational chart of the powertrain is shown in FIG. 2 and the operational chart is described hereinafter.

Such a powertrain may be operated according to the operational chart shown in FIG. 2 to realize six forward speeds and two reverse speeds. That is, the first clutch C1 and the first brake B1 are operated for the first forward speed, the first clutch C1 and the second brake B2 are operated for the second forward speed, the first clutch C1 and the third brake B3 are operated for the third forward speed, the first clutch C1 and the third clutch C3 are operated for the fourth forward speed, the third clutch C3 and the third brake B3 are operated for the fifth forward speed, the third clutch C3 and the second brake B2 are operated for the sixth forward speed, the second clutch C2 and the first brake B1 are operated for the first reverse speed R1, and the second clutch C2 and the second brake B2 are operated for the second reverse speed R2.

As with a general six-speed automatic transmission, a 1 to 1 speed ratio is realized between the input shaft and the output shaft for the fourth forward speed.

First, the TCU operates the first clutch C1 and the first brake B1 for the first forward speed. Therefore, the ring gear R1 of the first planetary gear set PG1 connected to the first clutch C1 rotates with the same speed and direction as the input shaft, and the carrier PC2 of the second planetary gear set PG2 connected to the first brake B1 is operated as the reaction element. At that time, the carrier PC1 of the first planetary gear set PG1 also stops.

Finally, the ring gear R1 of the first planetary gear set PG1 rotates by the input shaft, and the pinion gears P1 and P2 of the first and second planetary gear sets PG1 and PG2 integrally rotate by the reaction operation of the carrier PC1.

In addition, the ring gear R2 of the second planetary gear set PG2 rotates in the same direction as the input shaft, and the ring gear R2 of the second planetary gear set PG2 outputs a maximum speed ratio that the powertrain according to the exemplary embodiment of the present invention can provide. As a result, the powertrain according to the exemplary embodiment of the present invention realizes the first forward speed.

In a state of the first forward speed, if a vehicle speed increases, the TCU releases the first brake B1 and operates the second brake B2. At that time, the ring gear R1 of the first planetary gear set PG1 connected to the first clutch C1 maintains the same speed and direction as the input shaft because the first clutch C1 is operated continuously. Because the second brake B2 is operated, the sun gear S2 of the second planetary gear set PG2 stops so as to integral as the reaction element. Because the pinion gears P1 and P2 are integral between the first planetary gear set PG1 and the second planetary gear set PG2, the sun gear S2 of the second planetary gear set PG2 operates as the reaction element in the first planetary gear set PG1.

Therefore, the carriers PC1 and PC2 and the pinion gears P1 and P2 rotate simultaneously in the first planetary gear set PG1 and the second planetary gear set PG2. At that time, the carriers PC1 and PC2 and the pinion gears P1 and P2 rotate at the same speed in the first planetary gear set PG1 and the second planetary gear set PG2, and the rotation speed of the carrier PC2 and the ring gear R2 in the second planetary gear set PG2 is affected by the sun gear S2 of the second planetary gear set PG2.

Finally, the carriers PC1 and PC2 of the first and second planetary gear sets PG1 and PG2 rotate in the same direction as the ring gear R1 of the first planetary gear set PG1 and the input shaft. In addition, the ring gear R2 of the second planetary gear set PG2 rotates in the same direction, and at that time the ring gear R2 of the second planetary gear set PG2 outputs the speed ratio of the second forward speed as shown in FIG. 5.

In a state of the second forward speed, if the vehicle speed increases, the TCU releases the second brake B2 and operates the third brake B3. At that time, the ring gear R1 of the first planetary gear set PG1 connected to the first clutch C1 maintains the same rotation speed and direction as the input shaft. Because the third brake B3 operates, the sun gear S1 of the first planetary gear set PG1 operates as the reaction element. Because the pinion gears P1 and P2 are integral between the first planetary gear set PG1 and the second planetary gear set PG2, and the sun gear S1 of the first planetary gear set PG1 operates as the reaction element in the second planetary gear set PG2.

The carriers PC1 and PC2 and the pinion gears P1 and P2 rotate simultaneously in the first planetary gear set PG1 and the second planetary gear set PG2. At that time, the carriers PC1 and PC2 and the pinion gears P1 and P2 rotate at the same speed in the first planetary gear set PG1 and the second planetary gear set PG2. In addition, the rotation speed of the carrier PC2 and the ring gear R2 in the second planetary gear set PG2 is affected by the sun gear S1 of the first planetary gear set PG1. Finally, the carriers PC1 and PC2 of the first and second planetary gear sets PG1 and PG2 rotate in the same direction as the ring gear R1 of the first planetary gear set PG1 and the input shaft.

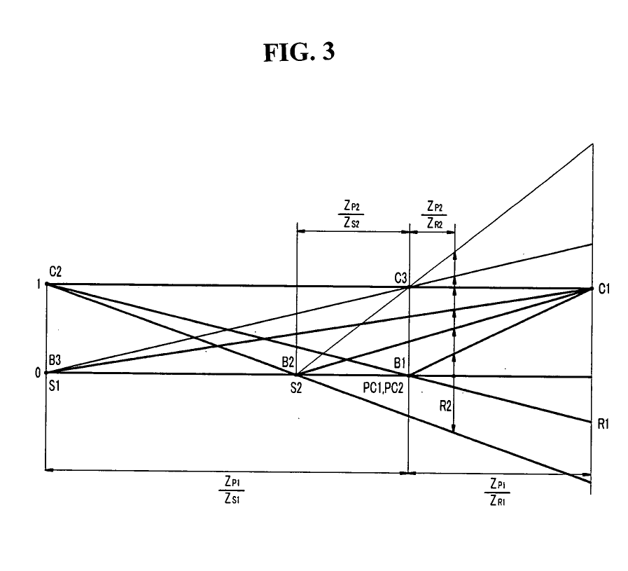

In addition, the ring gear R2 of the second planetary gear set PG2 receives the torque from the pinion gear P2 and rotates in the same direction. At that time the ring gear R2 of the second planetary gear set PG2 outputs the speed ratio of the second forward speed as shown in FIG. 3.

In a state of the third forward speed, if the vehicle speed increases, the TCU releases the third brake B3 and operates the third clutch C3. At that time, the ring gear R1 of the first planetary gear set PG1 connected to the first clutch C1 and the carrier PC1 of the first planetary gear set PG1 connected to the third clutch C3 input the rotating power of the input shaft. Therefore, the ring gear R1 and the carrier PC1 of the first planetary gear set PG1 maintain the same rotation speed and direction as the input shaft.

The first planetary gear set PG1 and the second planetary gear set PG2 integrally rotate with the input shaft. That is, because the carrier PC2 and the ring gear R2 of the output element integrally rotate with the input shaft, with which the second planetary gear set PG2 integrally rotates, the rotating power transmitted to the input shaft is directly output without passing through the planetary gear set.

As described above, for the fourth forward speed, the ring gear R2 of the second planetary gear set PG2 realizes a 1 to 1 speed ratio with the input shaft. In a state of the fourth forward speed, if the vehicle speed further increases, the TCU releases the first clutch C1 and operates the third brake B3. At that time, the carrier PC1 of the first planetary gear set PG1 connected to the third clutch C3 maintains the same speed and direction as the input shaft because the third clutch C3 operates continuously. Because the third brake B3 operates, the sun gear S1 of the first planetary gear set PG1 operates as the reaction element. The pinion gear P1 of the first planetary gear set PG1 rotates by the reaction operation of the sun gear S1. At that time, the pinion gears P1 and P2 of the two planetary gear sets PG1 and PG2 rotate with the same speed and direction as each other.

In addition, the rotating speed of the pinion gears P1 and P2 of the two planetary gear sets PG1 and PG2 and the ring gear R2 of the second planetary gear set PG2 is affected by the sun gear SI of the first planetary gear set PG1. Finally, in a state that the carriers PC1 and PC2 of the first and second planetary gear sets PG1 and PG2 rotate in the same direction as the input shaft, the ring gear R2 of the second planetary gear set PG2 also rotates in the same direction.

At that time, the pinion gear P2 and the ring gear R2 of the second planetary gear set PG2 rotate at the speed determined by the sun gear S1 of the first planetary gear set PG1. Therefore, as shown in FIG. 3, the ring gear R2 of the second planetary gear set PG2 outputs a speed ratio of the fifth forward speed rotating faster than the fourth forward speed.

In a state of the fifth forward speed, if the vehicle speed further increases, the TCU releases the third brake B3 and operates the second brake B2. At that time, the carrier PC1 of the first planetary gear set PG1 connected to the third clutch C3 maintains the same rotation speed and direction as the input shaft because the third clutch C3 operates continuously. Because the second brake B2 operates, the sun gear S2 of the second planetary gear set PG2 operates as the reaction element.

The pinion gear P2 of the second planetary gear set PG2 rotates by the reaction operation of the sun gear S2. At that time, the pinions P1 and P2 of the two planetary gear sets PG1 and PG2 rotate with the same speed and direction as each other. In addition, the rotating speed of the pinion gears P1 and P2 of the two planetary gear sets PG1 and PG2 and the ring gear R2 of the second planetary gear set PG2 is affected by the sun gear S2 of the second planetary gear set PG2.

Finally, the carrier PC2 of the second planetary gear set PG2 rotates identically with the input shaft, and the carrier PC1 of the first planetary gear set PG1 operates as the input element. In addition, because the stopped sun gear S2 of the second planetary gear set PG2 operates as the reaction element, in this state, only the second planetary gear set PG2 relates to a shift speed.

That is, in a state that the carriers PC1 and PC2 of the first and second planetary gear sets PG1 and PG2 rotate in the same direction as the input shaft, the ring gear R2 of the second planetary gear set PG2 also rotates in the same direction. At that time, the pinion gear P2 and the ring gear R2 of the second planetary gear set PG2 rotate at the speed determined by the sun gear S2 of the second planetary gear set PG2.

As a result, as shown in FIG. 3, the ring gear R2 of the second planetary gear set PG2 outputs a speed ratio of the sixth forward speed. On the other hand, the second clutch C2 and the first brake B1 are operated for the first reverse speed.

At that time, the sun gear S1 of the first planetary gear set PG1 connected to the second clutch C2 maintains the same rotation speed and direction as the input shaft. Because the first brake B1 operates, the carrier PC2 of the second planetary gear set PG2 operates as the reaction element.

In addition, the pinion gears P1 and P2 of the first and second planetary gear sets PG1 and PG2 rotate in a reverse direction with the sun gear S1 of the first planetary gear set PG1 by the reaction operation of the carrier PC2. Finally, the ring gear R2 of the second planetary gear set PG2 rotates in the reverse direction of the input shaft and the sun gear S1 of the first planetary gear set PG1.

At that time, as shown in FIG. 3, the ring gear R2 of the second planetary gear set PG2 outputs a speed ratio of the first reverse speed. In addition, for the second reverse speed, in a state of the first reverse speed, the TCU releases the first brake B1 and operates the second brake B2. At that time, the sun gear S1 of the first planetary gear set PG1 connected to the second clutch C2 maintains the same rotation speed and direction as the input shaft because the second clutch C2 is operated continuously. Because the second brake B2 operates, the sun gear S2 of the second planetary gear set PG2 operates as the reaction element. In addition, the pinion gears P1 and P2 of the first and second planetary gear sets PG1 and PG2 rotate in a reverse direction with the sun gear S1 of the first planetary gear set PG1 by the reaction operation of the sun gear S2.

Finally, the ring gear R2 of the second planetary gear set PG2 rotates in the reverse direction of the input shaft and the sun gear S1 of the first planetary gear set PG1. At that time, because the sun gear S2 of the second planetary gear set PG2 is fixed, not the carrier, the pinion gears P1 and P2 of the first and second planetary gear sets PG1 and PG2 rotate simultaneously. As a result, at that time, as shown in FIG. 5, the ring gear R2 of the second planetary gear set PG2 outputs a speed ratio of the second reverse speed.

As described above, in a six-speed powertrain of an automatic transmission for a vehicle according to the exemplary embodiment of the present invention, because the stepped pinion type planetary gear set is applied, a powertrain can be provided that can realize six forward speeds and two reverse speeds and have a reduced number of planetary gear sets.

Therefore, the powertrain according to the exemplary embodiment of the present invention is a transmission having a simpler scheme and smaller size. In addition, because the number of planetary gear sets is reduced, the transmission has a light weight and the manufacturing costs can be reduced.

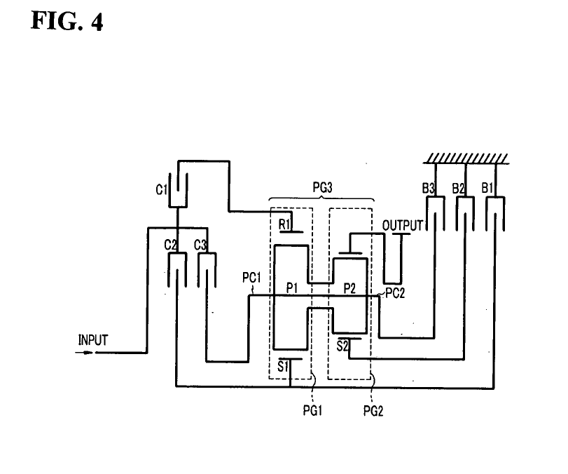

Referring to FIG. 4, a powertrain according to another exemplary embodiment of the present invention is similar to the exemplary embodiment in FIG. 1 except for the arrangement of the clutches. That is, according to this exemplary embodiment of the present invention, because a form of the arrangement of the clutches is minimized, the length of the powertrain system can be further minimized.

As described above, in a six-speed powertrain of an automatic transmission for a vehicle according to this exemplary embodiment of the present invention, a vehicle can realize six forward speeds and two reverse speeds, have a smaller number of planetary gear sets than that of the prior art by including a stepped pinion type planetary gear set that has corresponding pinion gears of two planetary gear sets connected to each other as one body, have a simpler scheme such that a small automatic transmission can be realized, have light weight, and have reduced manufacturing costs. In addition, according to the exemplary embodiments of the present invention, because the scheme of the powertrain is simplified, an arrangement of a hydraulic pressure supply line can be simply realized.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A six-speed powertrain of an automatic transmission for a vehicle, comprising a stepped pinion type planetary gear set in which two planetary gear sets are connected to each other by corresponding pinion gears.

2. A six-speed powertrain of an automatic transmission for a vehicle comprising:
a first planetary gear set receiving rotating power of an input shaft;
a second planetary gear set outputting the power after changing the speed,
wherein
a pinion gear of the first planetary gear set and a pinion gear of the second planetary gear set are connected to each other to form a stepped pinion type planetary gear set;
a plurality of clutches variably connecting operational elements of the first planetary gear set to an input shaft such that rotating power of the input shaft can be transmitted to a selected operational element of the first planetary gear set; and
a plurality of brakes disposed between a corresponding operational element of the two planetary gear sets and a transmission housing such that the plurality of brakes can stop a selected operational element of the first and second planetary gear sets.

3. The six-speed powertrain of claim 2, wherein:
the plurality of clutches includes first, second, and third clutches, respectively disposed between a ring gear, a sun gear, and a carrier of the first planetary gear set and the input shaft such that a respective operational element of the first planetary gear set can be variably connected to the input shaft,
the plurality of brakes includes first, second, and third brakes, respectively disposed between a carrier and a sun gear of the second planetary gear set, the sun gear of the first planetary gear set, and the transmission housing such that the plurality of brakes can stop the respective corresponding operational element, and
a ring gear of the second planetary gear set is connected to an output shaft such that the ring gear of the second planetary gear set always acts as an output element.
